(19) United States
(12) Patent Application Publication
(10) Pub. No.: US 2011/0046640 A1
(43) Pub. Date: Feb. 24, 2011

(54) Tool to assist use of animal ligation device

(76) Inventor: David B. Miller, Roxbury, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/804,856

(22) Filed: Jul. 30, 2010

Related U.S. Application Data
(60) Provisional application No. 61/273,197, filed on Jul. 31, 2009.

(51) Int. Cl. A61D 1/06

(52) U.S. Cl. 606/135

(57) ABSTRACT

A ring to assist in use of an animal ligation device has an inner diameter dimensioned for easy passage around a part of an animal to be removed by the ligation device, an outer diameter of the ring having an outer peripheral groove dimensioned for receipt of a ligature of the ligation device so as to assist in use of the ligation device relative to the animal. The ring is preferably made from a plastic material having the groove dimensioned for easy removal of the ligature after positionment of the ligature relative to the animal, so that completion of use of the ligation device is facilitated.

### CROSS REFERENCE TO RELATED APPLICATION

This application claims priority under 35 USC §119 to U.S. Provisional Patent Application No. 61/273,197 filed on Jul. 31, 2009.

### TECHNICAL FIELD

The present invention relates to a tool to assist use of an animal ligation device, specifically to assist in placing a ligature around an animal body part, such as to place a ligature over an animal's scrotum to assist in castration.

### BACKGROUND OF THE INVENTION

It is known in the art to use what is known as a bander or animal ligation device in order to assist in removing a body part from an animal by cutting off blood flow to the body part which thereby causes the body part ultimately to fall off from the animal. Such devices are used for animal castration, removal of animal tails, antler removal, and the like. A typical bander is known as the Callicrate Bander®, such as shown in U.S. Pat. No. 6,409,738. Such devices use a ligature which is placed around and above the animal part to be removed, such as above the scrotum so as to then allow for tightening of the ligature. Such tightening, if applied with sufficient tightness, will cut off blood supply to the animal part which effectively causes the animal part to fall off from the animal due to loss of blood. Such devices have been found to be humane in operation since little discomfort is caused to the animal by this process.

Nevertheless, for some animals, such as large bulls, the placement of the ligature up and above the scrotum (i.e., over the scrotal sac) of the animal can be difficult to perform with known devices. It is to provide a tool in assist in placement of the ligature above the animal part to be removed that the present invention is directed.

### SUMMARY OF THE INVENTION

A ring is provided having an inner diameter sufficiently large to easily be passed around an animal part to be removed, the ring being provided with an outer periphery having a groove formed therein, the groove dimensioned for receipt of a ligature used on a bander. For use with a bander specifically for the castration of bulls, the loop has an inside diameter of approximately 4″ and an outer diameter of 4½″, as well as a outer peripheral groove of approximately ⅜″ (0.375″). The height of the loop is typically 1″.

In use, the operator stretches the ligature (sometimes referred to as a band) around the ring so as to allow the band to settle into the peripheral groove of the ring. The operator then raises the ring up and over the animal part to be removed, such as the scrotum of a bull, and releases the ligature from the ring with a light upward movement of the hand typically with the thumb. This action releases the ligature from the ring allowing the ring to be removed away from the animal. The released ligature is then able to relax around the upper part of the animal part to be removed, such as the scrotum, whereby the operator can then continue with the normal operation of the bander for performing the castration or other part removal.

The loop is typically formed from plastic, such as polyvinylchloride (PVC) type plastic.

### BRIEF DESCRIPTION OF THE DRAWINGS AND PHOTOGRAPHS

FIG. 1 is a side view of a ring according to an embodiment of the present invention showing a ligature or band (in phantom) placed within the peripheral groove of the ring.

FIG. 2 is a top view of the ring illustrating the peripheral groove of the ring in phantom.

FIG. 3 illustrates a band placed around the ring with the band connected to a bander during use of the bander for removal of an animal part.

FIG. 4a shows the ligature or band on the bander prior to its positionment on the ring of the present invention.

FIG. 4b shows the ligature around the ring of the present invention from a side view.

FIG. 4c shows the ligature connected to the bander and placed around the ring from a top view thereof.

FIG. 5 is a perspective view of a bander and a ring of the present invention apart from each other.

### DETAILED DESCRIPTION

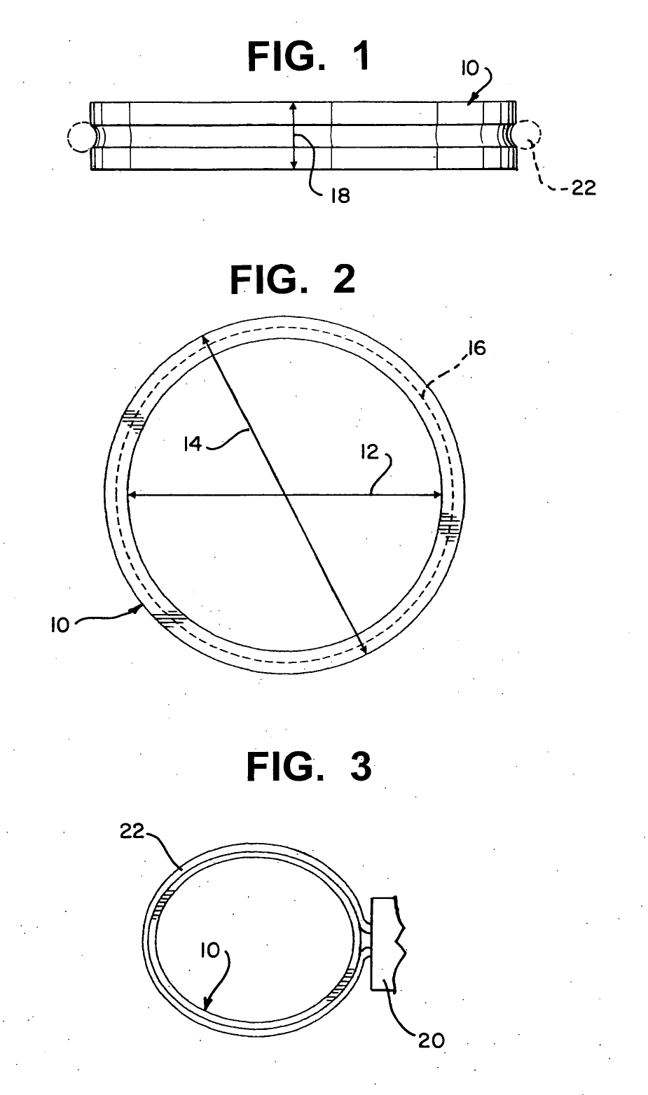

FIGS. 1 and 2 and 5 show a ring 10 according to the present invention, the ring having an inner diameter 12 and an outer diameter 14 with the outer periphery of the ring having a groove 16 formed therein dimensioned for receipt of a ligature or band, such as a piece of surgical tubing or the like which is used on a bander 20, such as shown in Photo 1.

In one embodiment, the ring has an inner diameter of 4″ and an outer diameter of 4.5″ and a height 18 of 1″. The peripheral groove 16 in this embodiment is dimensioned for receipt of a ligature 22 of approximately ⅜″.

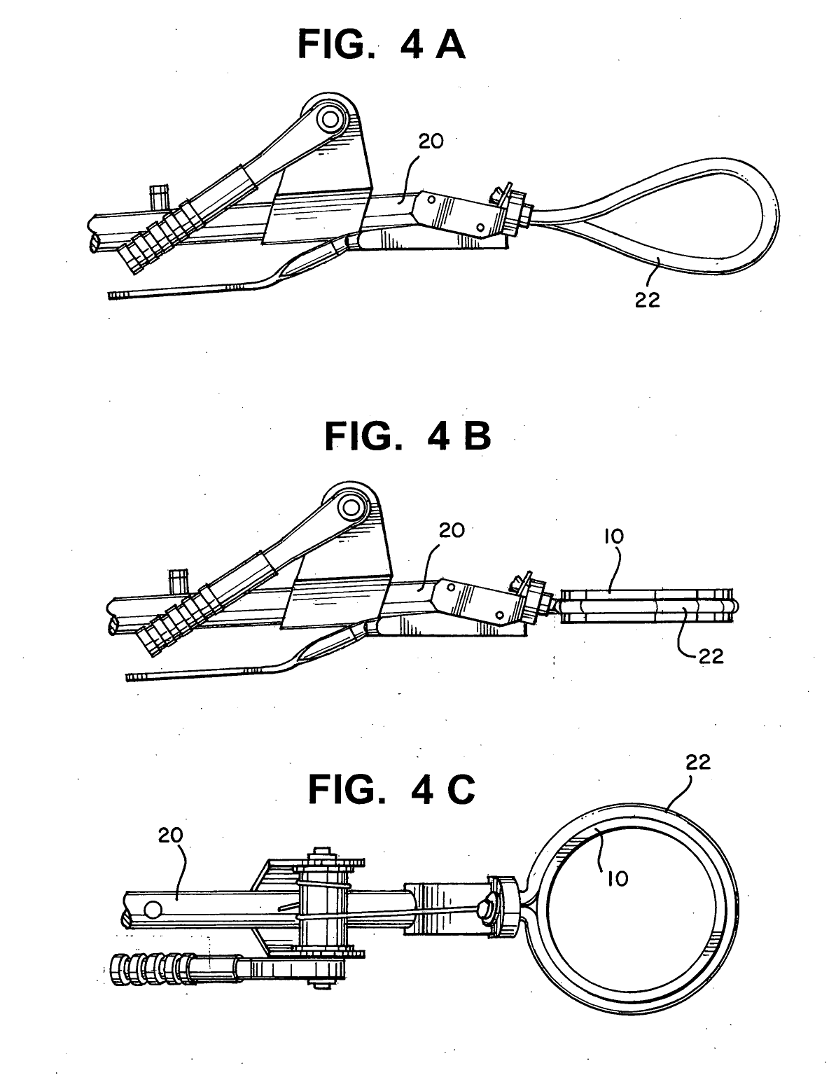

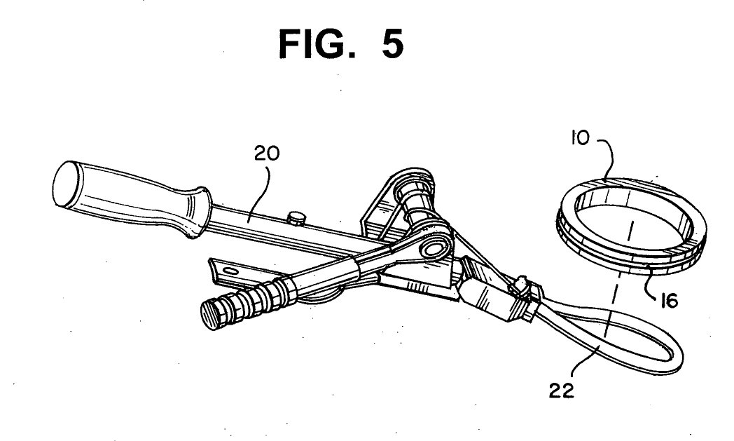

As seen in FIG. 5, the ligature or band 22 is looped on the bander prior to use of the bander, with the operator placing the ligature around the peripheral groove 16 of the ring. Once the band is positioned around the ring, as shown in FIGS. 4b and 4c, the bander can be used in its normal fashion in the animal part removal by simply moving the ligature positioned around the periphery of the ring up and over the animal part, such as up and over the scrotum of a bull. Once positioned in the location desired relative to the animal, the ring 10 is removed from the ligature by the operator applying a light upward force on the ligature, such as with the operator's thumb, which thereby releases the ligature from the peripheral groove freeing the ring from the ligature. At this point, the ring can simply be dropped away from the animal; its function having been performed. The bander is then used in its normal operation so as to tighten the ligature around the desired region of the animal, causing stoppage of blood flow to the animal part to be removed. In typical operation, the bander causes the ligature to be tightened to the desired amount about the animal part. The tightened ligature is left on the animal by the bander.

The ring can be dimensioned such that its inner diameter is sufficiently large so as to easily allow the ligature to be moved over the desired part of the animal to be removed without causing discomfort to the animal in that process. This is markedly different from trying to move the loop up and over the animal part without the use of the ring since such actions may easily cause contact between the ligature and/or the user's hand relative to the animal part.

The dimensions of the ring recited above are particularly useful for use of the device with a bander for the castration of bulls. Of course, other diameters would be applicable for different animal parts, such as the tail of animals, and for different animals, such as goats and the like.

The ring is preferably formed from a plastic material, such as polyvinylchloride (PVC), although it is realized to those of ordinary skill in the art that other materials could be used for the fabrication of the ring. Although the ring as shown in the photos is shown with a bander known under the brand name of Callicrate Bander®, the ring of the present invention can be used with other banders (animal ligation device) which use a ligature or band for tightening around an animal as described above.

Having described the invention, what is claimed is:

1. A device to assist in use of an animal ligation device comprising:
a ring having an inner diameter dimensioned for passage over an animal part to be removed by the ligation device, the ring having a peripheral groove formed therein, the peripheral groove dimensioned for receipt of a ligature of the ligation device so as to position the ligature about the ring during use of the ligation device with respect to the animal.

2. The ring as defined in claim 1 formed from polyvinylchloride-type plastic.

3. The ring as defined in claim 2 having an inner diameter of approximately 4″ and an outer diameter of approximately 4½″ and a peripheral groove dimensioned for receipt of a ligature having a thickness of approximately ⅜″ and a height of approximately 1″.
